(19) United States
(12) Patent Application Publication
(10) Pub. No.: US 2025/0058755 A1
(43) Pub. Date: Feb. 20, 2025

(54) BRAKING CONTROL DEVICE FOR VEHICLE

(71) Applicant: ADVICS CO., LTD., Kariya-shi, Aichi-ken (JP)

(72) Inventors: Daichi NAGAE, Kariya-shi, Aichi-ken (JP); Shunya WATANABE, Kariya-shi, Aichi-ken (JP)

(73) Assignee: ADVICS CO., LTD., Kariya-shi, Aichi-ken (JP)

(21) Appl. No.: 18/721,785

(22) PCT Filed: Dec. 22, 2022
(86) PCT No.: PCT/JP2022/047395

§ 371 Date: Jun. 19, 2024

(30) Foreign Application Priority Data
Dec. 22, 2021 (JP) 2021-208678

(51) Int. Cl. B60T 13/66; B60T 8/171; B60T 8/172; B60T 13/74

(52) U.S. Cl. CPC B60T 13/662; B60T 8/171; B60T 8/172; B60T 13/745; B60T 2220/04; B60T 2270/402; B60T 2270/404; B60T 2270/82

(57) ABSTRACT

A braking control device for vehicles that comprises: a first unit that outputs a supply pressure in accordance with the amount a braking operation member is operated; a second unit that is provided between the first unit and a wheel cylinder, regulates the supply pressure, and outputs a wheel pressure to the wheel cylinder; a communications bus that transfers signals between the first unit and the second unit; an operation amount sensor that is connected to the first unit and detects the operation amount; and a supply pressure sensor that is connected to the second unit and detects the supply pressure. The first unit calculates a target pressure on the basis of the operation amount, obtains the supply pressure from the second unit via the communications bus, and performs feedback control such that the supply pressure matches the target pressure.

### TECHNICAL FIELD

The present disclosure relates to a braking control device for a vehicle.

### BACKGROUND ART

The applicant has developed a braking control device for a vehicle as described in Patent Literature 1. For the purpose of “providing a brake control device configured by a brake-by-wire which has an excellent brake operation characteristic and two fluidically separated brake systems during normal braking”, Patent Literature 1 describes that “A brake control device of a vehicle includes: a first fluid passage to which two of four wheel cylinders are connected; a second fluid passage to which other two of the four wheel cylinders are connected; a piston which fluidically separates the first fluid passage from the second fluid passage; a simulator which is fluidically separated from the first and second fluid passages and applies operational force to a brake operation member; an electric pump which is connected to a reservoir; a pressure regulating valve which regulates brake liquid discharged by the electric pump to regulated liquid pressure; a reflux passage which returns the brake liquid passing the pressure regulating valve to a suction section of the electric pump; a servo chamber which is fluidically separated from the first and second fluid passages and the simulators and regulates liquid pressure of the first and second fluid passages through the piston by the regulated liquid pressure; and a controller which controls the electric pump and the pressure regulating valve”.

The device of Patent Literature 1 is provided with a pressure sensor that detects regulated liquid pressure, and the pressure regulating valve is feedback-controlled so that the detected regulated liquid pressure is brought close to and matches a target liquid pressure. Due to this, highly accurate fluid pressure control is achieved. In such a braking control device, it is desired that the fluid pressure feedback control is performed with a simple configuration.

### CITATIONS LIST

### Patent Literature

Patent Literature 1: JP 2020-032833 A

### SUMMARY

### Technical Problems

An object of the present disclosure is to provide a braking control device for a vehicle in which fluid pressure control including feedback control is performed, the braking control device for a vehicle having a simple configuration.

### Solutions to Problems

A braking control device (SC) for a vehicle according to the present disclosure includes: a first unit (SA) that outputs a supply pressure (Pm) in accordance with an operation amount (Sp) of a braking operation member (BP); a second unit (SB) that is provided between the first unit (SA) and a wheel cylinder (CW), adjusts the supply pressure (Pm), and outputs a wheel pressure (Pw) to the wheel cylinder (CW); a communication bus (BS) that performs signal transmission between the first unit (SA) and the second unit (SB); an operation amount sensor (SP) that is connected to the first unit (SA) and detects the operation amount (Sp); and a supply pressure sensor (PM) that is connected to the second unit (SB) and detects the supply pressure (Pm). The first unit (SA) calculates a target pressure (Pt) based on the operation amount (Sp), obtains the supply pressure (Pm) from the second unit (SB) via the communication bus (BS), and performs feedback control so as to cause the supply pressure (Pm) to match the target pressure (Pt).

The second unit SB includes a supply pressure sensor PM so as to perform wheel independent control such as anti-lock brake control and anti-skid control. The first unit SA obtains the supply pressure Pm via the communication bus BS. According to the above configuration, one supply pressure sensor PM is shared by pressure adjusting control and wheel independent control. Due to this, the overall configuration of the braking control device SC can be simplified.

In the braking control device (SC) for a vehicle according to the present disclosure, the operation amount sensor (SP) is connected also to the second unit (SB). When the first unit (SA) cannot obtain the supply pressure (Pm) (FP=1), the second unit (SB) calculates the target pressure (Pt) based on the operation amount (Sp), and adjusts the wheel pressure (Pw) based on a deviation (hp) between the target pressure (Pt) and the supply pressure (Pm). For example, when the supply pressure (Pm) is smaller than the target pressure (Pt), the second unit (SB) increases the wheel pressure (Pw) by an amount corresponding to the deviation (hP).

The above configuration is a simple configuration in which even when the first braking unit SA cannot obtain the supply pressure Pm and cannot perform the feedback control, the second braking unit SB can compensate excess or deficiency (i.e., fluid pressure error) of the supply pressure Pm, and can secure the pressure adjustment accuracy of the wheel pressure Pw.

### BRIEF DESCRIPTION OF DRAWINGS

FIG. 1 is a schematic view for explaining an entire vehicle JV mounted with a braking control device SC.

FIG. 2 is a schematic view for explaining a configuration example of a first braking unit SA.

FIG. 3 is a schematic view for explaining a configuration example of a second braking unit SB.

FIG. 4 is a flowchart for explaining processing of pressure adjusting control.

FIG. 5 is a block diagram for explaining drive control of a pressure adjusting valve UA.

FIG. 6 is a block diagram for explaining drive control of a control valve UB.

### DESCRIPTION OF EMBODIMENTS

### <Symbols of Constituent Members and the Like and Suffixes at the End of the Symbols>

In the following description, constituent members, calculation processing, signals, characteristics, and values denoted by identical symbols such as “CW” have identical functions. The suffixes “f” and “r” attached to the end of the symbol related to each wheel are comprehensive symbols indicating which system of front and rear wheels they relate to. For example, wheel cylinders CW provided on the respective wheels are described as “front wheel wheel cylinder CWf” and “rear wheel wheel cylinder CWr”. Furthermore, the suffixes “f” and “r” at the end of the symbols can be omitted. When the suffixes “f” and “r” are omitted, each symbol represents a generic term. For example, “CW” is a generic term for wheel cylinders provided on front and rear wheels of a vehicle.

In a fluid path from a master cylinder CM to a wheel cylinder CW, the side near the master cylinder CM (the side far from the wheel cylinder CW) is called “upper part”, and the side near the wheel cylinder CW (the side far from the master cylinder CM) is called “lower part”. In circulation flows KN and KL of a brake fluid BF in first and second fluid units YA and YB, the side near discharge portions of first and second fluid pumps QA and QB (the side away from a suction portion) is called “upstream side”, and the side near the suction portions of the first and second fluid pumps QA and QB (the side away from the discharge portion) is called “downstream side”.

The first fluid unit YA of the first braking unit SA, the second fluid unit YB of the second braking unit SB, and the wheel cylinder CW are connected by a fluid path (communication path HS). Furthermore, in the first and second fluid units YA and YB, various constituent elements (UA and the like) are connected by a fluid path. Here, the “fluid path” is a route for moving the brake fluid BF, and corresponds to a pipe, a flow path in an actuator, a hose, and the like. In the following description, the communication path HS, a reflux path HK, a return path HL, a reservoir path HR, an input path HN, a servo path HV, a decompression path HG, and the like are fluid paths.

<Vehicle JV Mounted with Braking Control Device SC>

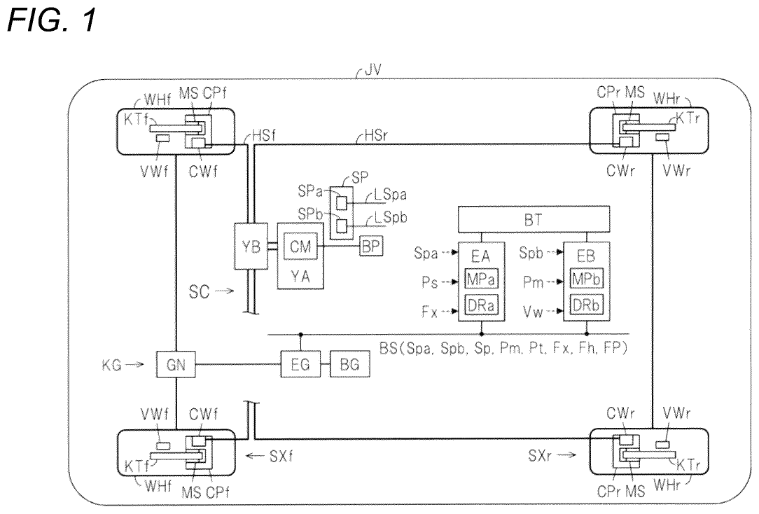

An overall configuration of the vehicle JV mounted with the braking control device SC according to the present disclosure will be described with reference to the schematic view of FIG. 1. The vehicle JV is a hybrid vehicle or an electric vehicle including a driving electric motor. The vehicle JV includes a regenerative device KG. The regenerative device KG includes a generator GN and a control unit EG (also called “regenerative controller”) for the regenerative device. The generator GN is also a driving electric motor. In regenerative braking, the electric motor/generator GN operates as an electrical generator, and the generated electric power is stored in a storage battery BG via the regenerative controller EG. For example, the regenerative device KG is included in a front wheel WHf. In this configuration, a regenerative braking force Fg is generated in the front wheel WHf by the regenerative device KG.

The vehicle JV includes front wheel and rear wheel braking devices SXf and SXr (=SX). The braking device SX includes a brake caliper CP, a friction member MS (e.g., brake pad), and a rotation member (e.g., brake disc) KT. The brake caliper CP is provided with the wheel cylinder CW. The friction member MS is pressed against the rotation member KT fixed to each wheel WH by the fluid pressure Pw (called “wheel pressure”) in the wheel cylinder CW. Due to this, a braking force Fm is generated in the wheel WH. The braking force generated by a wheel pressure Pw is called “friction braking force Fm”.

The vehicle JV includes the braking operation member BP and various sensors (SP and the like). The braking operation member (e.g., brake pedal) BP is a member operated by the driver to decelerate the vehicle JV. The vehicle JV is provided with the operation displacement sensor SP that detects operation displacement Sp of the braking operation member BP. The operation displacement Sp is one of state quantities (state variables) for displaying the operation amount (braking operation amount) of the braking operation member BP, and in the braking control device SC of a brake-by-wire type, the operation displacement Sp is a signal (i.e., braking instruction) indicating the braking intention of the driver.

The operation displacement sensor SP (corresponding to an “operation amount sensor”) includes two detection portions SPa and SPb (“first and second detection portions”). That is, detection of the operation displacement Sp is performed double, and the operation displacement sensor SP is made redundant. The first detection portion SPa (called a “first displacement detection portion”) of the operation displacement sensor SP is connected to the first braking unit SA (in particular, a first control unit EA) by a first displacement signal line LSpa. On the other hand, the second detection portion SPb (called a “second displacement detection portion”) of the operation displacement sensor SP is connected to the second braking unit SB (in particular, a second control unit EB) by a second displacement signal line LSpb. Therefore, a signal Spa (called “first operation displacement”) of the first displacement detection portion SPa is directly input to the first control unit EA. On the other hand, a signal Spb (called “second operation displacement”) of the second displacement detection portion SPb is directly input to the second control unit EB. For example, the “signal lines LSpa and LSpb” are electric wires (wire harnesses) for signal communication.

In addition to the operation displacement sensor SP, a fluid pressure Ps (called a “simulator pressure”) of a stroke simulator SS is adopted as another state quantity representing a braking operation amount. The simulator pressure Ps is detected by a simulator pressure sensor PS. The simulator pressure sensor PS is connected to the first braking unit SA (in particular, a first control unit EA) by a simulator pressure signal line LPs. Therefore, the simulator pressure Ps is directly input to the first control unit EA. The simulator pressure Ps is a state quantity corresponding to an operation force of the braking operation member BP.

The vehicle JV includes various sensors. For braking control (called “wheel independent control”) for individually controlling the wheel pressure Pw of each wheel WH, such as anti-lock brake control and anti-skid control, the wheel WH includes the wheel speed sensor VW that detects the rotation speed (wheel speed) Vw thereof. A steering amount sensor that detects a steering amount Sa (e.g., an operation angle of the steering wheel), a yaw rate sensor that detects a yaw rate Yr of the vehicle, a longitudinal acceleration sensor that detects a longitudinal acceleration Gx of the vehicle, and a lateral acceleration sensor that detects a lateral acceleration Gy of the vehicle are included (not illustrated). Each of the signals of the wheel speed Vw, the steering amount Sa, the yaw rate Yr, the longitudinal acceleration Gx, and the lateral acceleration Gy are input to the second braking unit SB (in particular, the second control unit EB) via respective signal lines.

The vehicle JV includes the braking control device SC. In the braking control device SC, a so-called front-rear type (also called “type II”) is adopted as a two-system braking system. The braking control device SC adjusts the actual wheel pressure Pw.

The braking control device SC includes the two braking units SA and SB. The first braking unit SA includes the first fluid unit YA and the first control unit EA. The first fluid unit YA is controlled by the first control unit EA using, as a power source, a storage battery BT (braking storage battery) different from the driving storage battery BG. The second braking unit SB includes the second fluid unit YB and the second control unit EB. Similarly to the first braking unit SA, the second fluid unit YB is controlled by the second control unit EB using the storage battery BT as a power source.

The first braking unit SA (in particular, the first control unit EA) and the second braking unit SB (in particular, the second control unit EB) are connected to a communication bus BS. The regenerative device KG (in particular, the regenerative control unit EG) is connected to the communication bus BS. The “communication bus BS” has a network structure in which a plurality of control units (also called “controllers”) are put from a communication line terminated at both ends. Signal communication is performed among a plurality of controllers (EA, EB, EG, and the like) by the communication bus BS. That is, the plurality of controllers can transmit signals (detection values, calculation values, control flags, and the like) to the communication bus BS and receive signals from the communication bus BS. For example, a vehicle bus (an internal communication network that interconnects controllers in a vehicle) is adopted as the communication bus BS, and the CAN is used for a serial communication protocol. The communication bus BS includes a communication line (e.g., a CAN bus cable) and a transmission/reception microcontroller in each controller.

### <First Braking Unit SA>

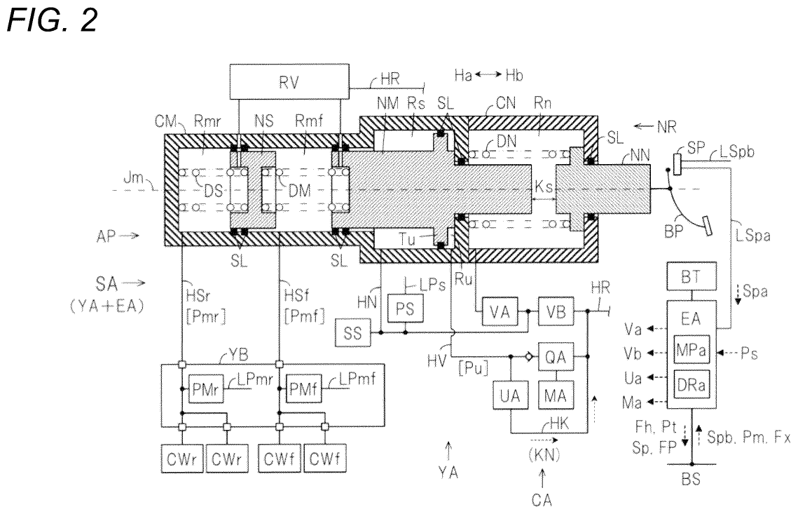

A configuration example of the first braking unit SA (corresponding to the “first unit”) of the braking control device SC will be described with reference to the schematic view of FIG. 2. The first braking unit SA generates the supply pressure Pm in accordance with the operation of the braking operation member BP (brake pedal). The supply pressure Pm is finally supplied to the wheel cylinder CW via the communication path HS (fluid path) and the second braking unit SB. The first braking unit SA includes the first fluid unit YA and the first control unit EA.

### <<First Fluid Unit YA>>

The first fluid unit YA (also called a “first actuator”) includes an application portion AP, a pressure adjusting portion CA, and an input portion NR.

### [Application Portion AP]

The supply pressure Pm is output from the application portion AP in accordance with the operation of the braking operation member BP. The application portion AP includes a tandem master cylinder CM, and primary and secondary master pistons NM and NS.

The primary and secondary master pistons NM and NS are inserted into the tandem master cylinder CM. The inside of the master cylinder CM is sectioned into four fluid pressure chambers Rmf, Rmr, Ru, and Rs by the two master pistons NM and NS. Front wheel and rear wheel master chambers Rmf and Rmr (=Rm) are sectioned by one side bottom part of the master cylinder CM and the master pistons NM and NS. Furthermore, the inside of the master cylinder CM is partitioned into a servo chamber Ru and a reaction force chamber Rs by a flange portion Tu of the master piston NM. The master chamber Rm and the servo chamber Ru are disposed so as to face each other across the flange portion Tu. Here, a pressure receiving area rm of the master chamber Rm and a pressure receiving area ru of the servo chamber Ru are made equal.

At the time of non-braking, the master pistons NM and NS are at the most retracted positions (i.e., the position where the volume of the master chamber Rm is maximized). In this state, the master chamber Rm of the master cylinder CM communicates with a master reservoir RV. The brake fluid BF is stored inside the master reservoir RV (that is an atmospheric pressure reservoir, and also simply called a “reservoir”). When the braking operation member BP is operated, the master pistons NM and NS are moved in a forward direction Ha (direction in which the volume of the master chamber Rm decreases). By this movement, communication between the master chamber Rm and the reservoir RV is cut off. When the master pistons NM and NS are further moved in the forward direction Ha, front wheel and rear wheel supply pressures Pmf and Pmr (=Pm) are increased from “0 (atmospheric pressure)”. Due to this, the brake fluid BF pressurized to the supply pressure Pm is output (pumped) from the master chamber Rm of the master cylinder CM. Since the supply pressure Pm is the fluid pressure of the master chamber Rm, it is also called a “master pressure”.

### [Pressure Adjusting Portion CA]

The pressure adjusting portion CA supplies the servo chamber Ru of the application portion AP with a servo pressure Pu. The pressure adjusting portion CA includes a first electric motor MA, the first fluid pump QA, and the pressure adjusting valve UA.

The first electric motor MA drives the first fluid pump QA. In the first fluid pump QA, the suction portion and the discharge portion are connected by the reflux path HK (fluid path). The suction portion of the first fluid pump QA is also connected to the master reservoir RV via the reservoir path HR. The discharge portion of the first fluid pump QA is provided with a check valve.

The reflux path HK is provided with the pressure adjusting valve UA of a normally-opened type. The pressure adjusting valve UA is a linear electromagnetic valve whose valve opening amount is continuously controlled based on an energized state (e.g., supply current). Since the pressure adjusting valve UA adjusts a fluid pressure deviation (differential pressure) between the upstream side and the downstream side thereof, it is also called a “differential pressure valve”.

When the brake fluid BF is discharged from the first fluid pump QA, the circulation flow KN (indicated by the broken line arrow) of the brake fluid BF is generated in the reflux path HK. When the pressure adjusting valve UA is in a fully opened state (at the time of non-energization since the pressure adjusting valve UA is a normally-opened type), the fluid pressure Pu (called “servo pressure”) between the discharge portion of the first fluid pump QA and the pressure adjusting valve UA is “0 (atmospheric pressure)” in the reflux path HK. When the energization amount (supply current) to the pressure adjusting valve UA is increased, the circulation flow KN (flow of the brake fluid BF circulating in the reflux path HK) is throttled by the pressure adjusting valve UA. In other words, the flow path of the reflux path HK is narrowed by the pressure adjusting valve UA, and an orifice effect by the pressure adjusting valve UA is exerted. Due to this, the fluid pressure Pu on the upstream side of the pressure adjusting valve UA is increased from “0”. That is, in the circulation flow KN, a fluid pressure deviation (differential pressure) between the fluid pressure Pu (servo pressure) on the upstream side and the fluid pressure (atmospheric pressure) on the downstream side is generated with respect to the pressure adjusting valve UA. The differential pressure is adjusted by the energization amount to the pressure adjusting valve UA.

The reflux path HK is connected to the servo chamber Ru via the servo path HV (fluid path) at a portion between the discharge portion of the first fluid pump QA and the pressure adjusting valve UA. Therefore, the servo pressure Pu is introduced (supplied) to the servo chamber Ru. By the increase in the servo pressure Pu increases, the master pistons NM and NS are pressed in the forward direction Ha (direction in which the volume of the master chamber Rm decreases), and the fluid pressures Pmf and Pmr (front wheel and rear wheel supply pressures) in the front wheel and rear wheel master chambers Rmf and Rmr are increased.

Front wheel and rear wheel communication paths HSf and HSr (=HS) are connected to the front wheel and rear wheel master chambers Rmf and Rmr (=Rm). The front wheel and rear wheel communication paths HSf and HSr are connected to the front wheel and rear wheel wheel cylinders CWf and CWr (=CW) via the second braking unit SB (in particular, the second fluid unit YB). Therefore, the front wheel and rear wheel supply pressures Pmf and Pmr are supplied from the first braking unit SA to the front wheel and rear wheel wheel cylinders CWf and CWr. Here, the front wheel supply pressure Pmf and the rear wheel supply pressure Pmr are equal (i.e., “Pmf=Pmr”).

### [Input Portion NR]

The braking operation member BP is operated by the input portion NR so as to achieve the regenerative cooperative control, but a state in which the wheel pressure Pw is not generated is generated. The “regenerative cooperative control” is to cooperate the friction braking force Fm (braking force by the wheel pressure Pw) and the regenerative braking force Fg (braking force by the generator GN) so that kinetic energy of the vehicle JV can be efficiently recovered into electric energy at the time of braking. The input portion NR includes an input cylinder CN, an input piston NN, an introduction valve VA, an opening valve VB, the stroke simulator SS, and a simulator fluid pressure sensor PS.

The input cylinder CN is fixed to the master cylinder CM. The input piston NN is inserted into the input cylinder CN. The input piston NN is mechanically connected to the braking operation member BP via a clevis (U-shaped link) so as to link with the braking operation member BP (brake pedal). The end surface of the input piston NN and the end surface of the primary piston NM have a gap Ks (also called “separation displacement”). The regenerative cooperative control is achieved by adjusting the separation distance Ks by the servo pressure Pu.

An input chamber Rn of the input portion NR is connected to the reaction force chamber Rs of the application portion AP via the input path HN (fluid path). The input path HN is provided with the introduction valve VA of a normally-closed type. The input path HN is connected to the master reservoir RV via the reservoir path HR between the introduction valve VA and the reaction force chamber Rs. The reservoir path HR is provided with the opening valve VB of a normally-opened type. The introduction valve VA and the opening valve VB are on-off type electromagnetic valves. The stroke simulator SS (also simply called a “simulator”) is connected to the input path HN between the introduction valve VA and the reaction force chamber Rs.

When power supply (power feed) is not performed to the introduction valve VA and the opening valve VB, the introduction valve VA is closed, and the opening valve VB is opened. The input chamber Rn is sealed and fluidly locked by the closing of the introduction valve VA. Due to this, the master pistons NM and NS are displaced integrally with the braking operation member BP. The simulator SS communicates with the master reservoir RV by the opening of the opening valve VB. When power supply (power feed) is performed to the introduction valve VA and the opening valve VB, the introduction valve VA is opened, and the opening valve VB is closed. Due to this, the master pistons NM and NS can be displaced separately from the braking operation member BP. At this time, since the input chamber Rn is connected to the stroke simulator SS, the operation force Fp of the braking operation member BP is generated by the simulator SS.

A state in which the master pistons NM and NS and the braking operation member BP are displaced separately (at the time of energization of the electromagnetic valves VA and VB) is called the “first mode (or, a by-wire mode)”. In the first mode, the braking control device SC functions as a brake-by-wire type device (i.e., a device that can independently generate the friction braking force Fm with respect to the braking operation of the driver).

Therefore, in the first mode, the wheel pressure Pw is generated independently of the operation of the braking operation member BP. On the other hand, a state in which the master pistons NM and NS and the braking operation member BP are integrally displaced (at the time of non-energization of the electromagnetic valves VA and VB) is called the “second mode (or, a manual mode)”. In the second mode, the wheel pressure Pw is linked with the braking operation of the driver. In the input portion NR, one of the first mode (by-wire mode) and the second mode (manual mode) is selected depending on the presence or absence of power feed to the introduction valve VA and the opening valve VB. When a power failure occurs in the braking control device SC (e.g., a failure or the like of the storage battery BT), the input portion NR is brought into the second mode.

The input path HN is provided with the simulator pressure sensor PS between the introduction valve VA and the reaction force chamber Rs so as to detect the fluid pressure Ps (simulator pressure) in the simulator SS. The simulator pressure sensor PS is connected to the first control unit EA by the simulator pressure signal line LPs. Therefore, the simulator pressure Ps is directly input to the first control unit EA via the simulator pressure signal line LPs.

### <<First Control Unit EA>>

The first control unit EA (also called a “first controller”) controls a first actuator YA. The first controller EA includes a first microprocessor MPa and a first drive circuit DRa. The first controller EA is connected to the communication bus BS so that signals (detection values, calculation values, control flags, and the like) can be shared with other controllers (EB, EG, and the like).

The first controller EA and the first detection portion SPa of the operation displacement sensor SP are connected via the signal line LSpa for the first detection portion SPa. The first controller EA and the simulator pressure sensor PS are connected via the signal line LPs for the simulator pressure sensor PS. The first operation displacement Spa and the simulator pressure Ps are directly input to the first controller EA through these signal lines LSpa and LPs.

A pressure adjusting control algorithm is programmed in the first controller EA (in particular, the first microprocessor MPa). The “pressure adjusting control” is a control for adjusting the supply pressure Pm (as a result, the wheel pressure Pw), and includes regenerative cooperative control. The pressure adjusting control is performed based on the first and second operation displacements Spa and Spb, the simulator pressure Ps, the supply pressure Pm, and a maximum regenerative braking force Fx.

Based on the algorithm of the pressure adjusting control, the first drive circuit DRa drives the first electric motor MA constituting the first actuator YA and various electromagnetic valves (UA and the like). In the first drive circuit DRa, an H bridge circuit is configured by switching elements (e.g., MOS-FET) so as to drive the first electric motor MA. The first drive circuit DRa includes a switching element so as to drive various electromagnetic valves (UA and the like). In addition, the first drive circuit DRa includes a motor current sensor (not illustrated) that detects a supply current Im (actual value) to the first electric motor MA, and a first current sensor (not illustrated) that detects a supply current Ia (actual value, and called a “first supply current”) to the pressure adjusting valve UA. The first electric motor MA is provided with a rotation speed sensor (not illustrated) that detects a rotation speed Na (actual value) thereof. The first electric motor MA may be provided with a rotation angle sensor (not illustrated) that detects a rotation angle Ka (actual value), and the motor rotation speed Na may be calculated based on the motor rotation angle Ka.

The first controller EA calculates a first target current Ita (target value) corresponding to the first supply current Ia based on the operation displacement Sp (operation amount). The first supply current Ia is controlled so as to be brought close to and match the first target current Ita (so-called current feedback control). The first controller EA calculates a target rotation speed Nta (target value) corresponding to the actual rotation speed Na based on the operation displacement Sp. A motor supply current Im is controlled so that the actual rotation speed Na is brought close to and matches the target rotation speed Nta (so-called rotation speed feedback control). A drive signal Ma for controlling the first electric motor MA and drive signals Ua, Va, and Vb for controlling the various electromagnetic valves UA, VA, and VB are calculated based on these control algorithms. The switching element of the first drive circuit DRa is driven in accordance with the drive signal (Ma and the like), and the first electric motor MA and the electromagnetic valves UA, VA, and VB are controlled.

### <Second Braking Unit SB>

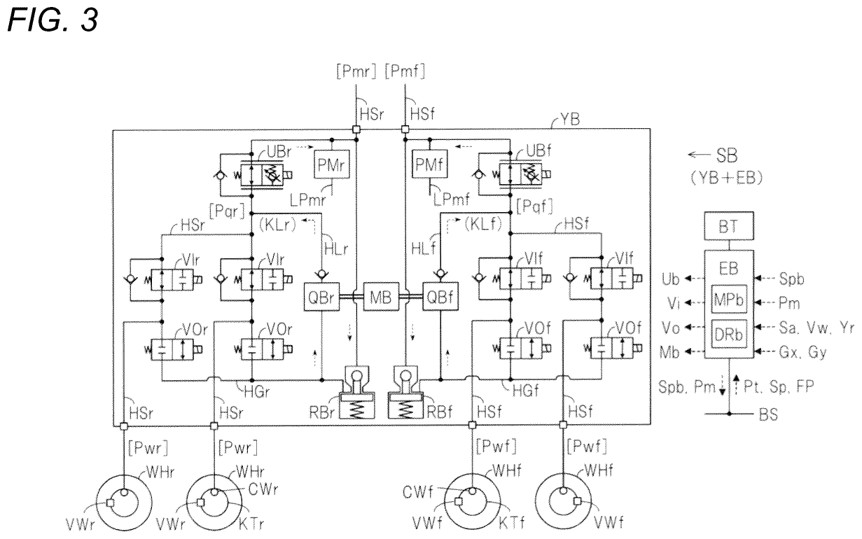

A configuration example of the second braking unit SB (corresponding to the “second unit”) of the braking control device SC will be described with reference to the schematic view of FIG. 3. The second braking unit SB is a general-purpose unit (device) for performing wheel independent control such as anti-lock brake control, traction control, and anti-skid control. In addition, the second braking unit SB performs complement control. The “complement control” compensates for excess or deficiency of the supply pressure Pm caused by the abnormality of the first braking unit SA.

The second braking unit SB is supplied with the front wheel and rear wheel supply pressures Pmf and Pmr (=Pm) from the first braking unit SA. The front wheel and rear wheel supply pressures Pmf and Pmr are adjusted (increased or decreased) by the second braking unit SB, and are output as fluid pressures Pwf and Pwr (front wheel and rear wheel wheel pressures) of the front wheel and rear wheel wheel cylinders CWf and CWr. The second braking unit SB includes the second fluid unit YB and the second control unit EB.

### <<Second Fluid Unit YB>>

The second fluid unit YB (also called a “second actuator”) is provided between the first actuator YA and the wheel cylinder CW in the communication path HS. The second actuator YB includes the supply pressure sensor PM, the control valve UB, the second fluid pump QB, a second electric motor MB, a pressure adjusting reservoir RB, an inlet valve VI, and an outlet valve VO.

Front wheel and rear wheel control valves UBf and UBr (=UB) are provided on the front wheel and rear wheel communication paths HSf and HSr (=HS). Similarly to the pressure adjusting valve UA, the control valve UB is a normally-opened type linear electromagnetic valve (differential pressure valve). By the control valve UB, the wheel pressure Pw can be individually increased from the supply pressure Pm in a front and rear wheel system.

Front wheel and rear wheel supply pressure sensors PMf and PMr (=PM) are provided above the front wheel and rear wheel control valves UBf and UBr (portion of the communication path HS on the side near the first actuator YA) so as to detect the actual fluid pressures Pmf and Pmr (front wheel and rear wheel supply pressures) supplied from the first actuator YA (in particular, the front wheel and rear wheel master chambers Rmf and Rmr). The supply pressure sensor PM is also called a “master pressure sensor” and is built in the second actuator YB. The front wheel and rear wheel supply pressure sensors PMf and PMr are connected to the second braking unit SB (in particular, the second control unit EB) by front wheel and rear wheel supply pressure signal lines LPmf and LPmr (=LPm). That is, the signals of the front wheel and rear wheel supply pressures Pmf and Pmr (=Pm) are directly input to the second control unit EB. Since the front wheel supply pressure Pmf and the rear wheel supply pressure Pmr are substantially the same, any one of the front wheel and rear wheel supply pressure sensors PMf and PMr may be omitted. For example, in a configuration in which the rear wheel supply pressure sensor PMr is omitted, only the front wheel supply pressure Pmf is detected by the front wheel supply pressure sensor PMf, and is directly input to the second control unit EB.

Upper parts of the front wheel and rear wheel control valves UBf and UBr (portions of the communication path HS on the side near the first actuator YA) and lower parts of the front wheel and rear wheel control valves UBf and UBr (portions of the communication path HS on the side near the wheel cylinder CW) are connected by front wheel and rear wheel return paths HLf and HLr (=HL). The front wheel and rear wheel return paths HLf and HLr are provided with front wheel and rear wheel fluid pumps QBf and QBr (=QB) and front wheel and rear wheel pressure adjusting reservoirs RBf and RBr (=RB). The second fluid pump QB is driven by the second electric motor MB.

When the second electric motor MB is driven, the brake fluid BF is sucked from the upper part of the control valve UB and discharged to the lower part of the control valve UB by the second fluid pump QB. Due to this, a circulation flow KL (i.e., front wheel and rear wheel circulation flows KLf and KLr, indicated by broken line arrows) of the brake fluid BF including the pressure adjusting reservoir RB is generated in the communication path HS and the return path HL. When the control valve UB narrows the flow path of the communication path HS and throttles the circulation flow KL of the brake fluid BF, a fluid pressure Pq (called “adjustment pressure”) in the lower part of the control valve UB is increased from the fluid pressure Pm (supply pressure) in the upper part of the control valve UB by the orifice effect at that time. In other words, in the circulation flow KL, a fluid pressure deviation (differential pressure) between the fluid pressure Pm (supply pressure) on the downstream side and the fluid pressure Pq (adjustment pressure) on the upstream side with respect to the control valve UB is adjusted by the control valve UB. In the magnitude relationship between the supply pressure Pm and the adjustment pressure Pq, the adjustment pressure Pq is equal to or greater than the supply pressure Pm (i.e., “Pq≥Pm”). As described above, the generation mechanism of the adjustment pressure Pq in the second actuator YB is the same as the generation mechanism of the servo pressure Pu in the first actuator YA.

Inside the second actuator YB, the front wheel and rear wheel communication paths HSf and HSr are each branched into two, and connected to the front wheel and rear wheel wheel cylinders CWf and CWr, respectively. In order to individually adjust each wheel pressure Pw, the inlet valve VI of a normally-opened type and the outlet valve VO of a normally-closed type are provided for each wheel cylinder CW. Specifically, the inlet valve VI is provided in the branched communication path HS (i.e., the side near the wheel cylinder CW with respect to the branch portion of the communication path HS). The communication path HS is connected to the pressure adjusting reservoir RB via the decompression path HG at a lower part (portion of the communication path HS on a side near the wheel cylinder CW) of the inlet valve VI. The outlet valve VO is disposed in the decompression path HG. On-off type electromagnetic valves are adopted as the inlet valve VI and the outlet valve VO. The wheel pressure Pw can be individually reduced from the supply pressure Pm at each wheel by the inlet valve VI and the outlet valve VO.

When power feed is not performed to the inlet valve VI and the outlet valve VO and their operations are stopped, the inlet valve VI is opened and the outlet valve VO is closed. In this state, the wheel pressure Pw is equal to the adjustment pressure Pq. The wheel pressure Pw is independently adjusted for each wheel cylinder CW by driving of the inlet valve VI and the outlet valve VO. In order to reduce the wheel pressure Pw, the inlet valve VI is closed and the outlet valve VO is opened. The inflow of the brake fluid BF into the wheel cylinder CW is blocked and the brake fluid BF in the wheel cylinder CW flows out to the pressure adjusting reservoir RB, and therefore the wheel pressure Pw is decreased. In order to increase the wheel pressure Pw (however, the upper limit of the increase is up to the adjustment pressure Pq), the inlet valve VI is opened and the outlet valve VO is closed. The outflow of the brake fluid BF to the pressure adjusting reservoir RB is blocked and the adjustment pressure Pq from the pressure adjusting valve UB is supplied to the wheel cylinder CW, and therefore the wheel pressure Pw is increased. In order to maintain the wheel pressure Pw, both the inlet valve VI and the outlet valve VO are closed. Since the wheel cylinder CW is fluidly sealed, the wheel pressure Pw is maintained constant.

### <<Second Control Unit EB>>

The second control unit EB (also called a “second controller”) controls the second actuator YB. Similarly to the first controller EA, the second controller EB includes a second microprocessor MPb and a second drive circuit DRb. The second controller EB is connected to the communication bus BS. Therefore, the first controller EA and the second controller EB can share signals via the communication bus BS.

The wheel speed Vw, the steering amount Sa, the yaw rate Yr, the longitudinal acceleration Gx, and the lateral acceleration Gy are input to the second controller EB (in particular, the second microprocessor MPb). The second controller EB calculates a vehicle body speed Vx based on the wheel speed Vw. The second controller EB performs wheel independent control listed below. Specifically, as the wheel independent control, anti-lock brake control (so-called ABS control) for suppressing lock of the wheel WH, traction control for suppressing spinning of a driving wheel, and anti-skid control (so-called ESC) for suppressing understeer and oversteer to improve directional stability of the vehicle are performed.

The second drive circuit DRb drives the second electric motor MB constituting the second actuator YB and various electromagnetic valves (UB and the like) in accordance with a control algorithm programmed in the second microprocessor MPb. In the second drive circuit DRb, an H bridge circuit is configured by switching elements (e.g., MOS-FET) so as to drive the second electric motor MB. The second drive circuit DRb includes a switching element so as to drive various electromagnetic valves (UB and the like). In addition, the second drive circuit DRb includes a motor current sensor (not illustrated) that detects a supply current In (actual value) to the second electric motor MB, and a second current sensor (not illustrated) that detects a supply current Ib (actual value, and called a “second supply current”) to the control valve UB. A drive signal Ub of the control valve UB, a drive signal Vi of the inlet valve VI, a drive signal Vo of the outlet valve VO, and a drive signal Mb of the second electric motor MB are calculated based on the control algorithm of the second microprocessor MPb. Based on the drive signal (Ub or the like), the second drive circuit DRb controls the second electric motor MB and the electromagnetic valves UB, VI, and VO.

The second controller EB and the second detection portion SPb of the operation displacement sensor SP are connected via the signal line LSpb for the second detection portion SPb. The second controller EB and the supply pressure sensor PM are connected via the signal line LPm (e.g., signal pin) for the supply pressure sensor PM. Therefore, the second operation displacement Spb is directly input to the second controller EB through the signal line LSpb, and the supply pressure Pm is directly input to the second controller EB through the signal line LPm. The second operation displacement Spb and the supply pressure Pm are transmitted from the second controller EB to the first controller EA through the communication bus BS. That is, in the first controller EA, the second operation displacement Spb and the supply pressure Pm are obtained from the second controller EB through the communication bus.

The second controller EB performs, in addition to the wheel independent control described above, complement control so as to cope with abnormality of the braking control device SC. In the complement control, a decrease in performance of the first braking unit SA is compensated by the second braking unit SB.

### <Processing of Pressure Adjusting Control>

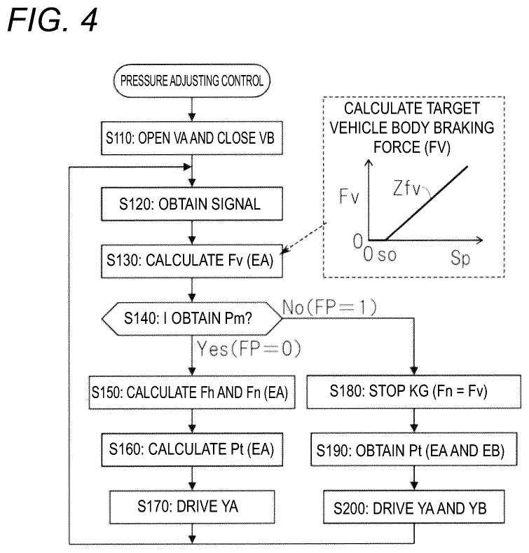

A processing example of the pressure adjusting control will be described with reference to FIGS. 4 to 6. The pressure adjusting control includes, in addition to the regenerative cooperative control, complement control corresponding to a state (also called “obtainment abnormality”) in which the supply pressure Pm is not appropriately obtained in the first braking unit SA (in particular, the first controller EA). An algorithm of the pressure adjusting control is programmed in the microprocessors MPa and MPb of the first and second controllers EA and EB.

The first controller EA obtains the supply pressure Pm from the second controller EB via the communication bus BS. Here, the communication bus BS includes a communication line and transmission/reception (communication) microcontrollers in the first and second controllers EA and EB. Therefore, the obtainment abnormality of the supply pressure Pm is generated due to disconnection of the communication line, failure of the communication microcontroller, or the like. A state in which there is an abnormality in the communication bus BS and the function thereof cannot be normally exhibited is called “communication abnormality”. Therefore, the obtainment abnormality of the supply pressure Pm is caused by communication abnormality.

The description of the processing example assumes the following.
The regenerative device KG is included only on the front wheel WHf. Therefore, the regenerative braking force Fg acts on the front wheel WHf but does not act on a rear wheel WHr.
When the braking control device SC operates normally, the second actuator YB is not driven, and only the first actuator YA is driven. Therefore, since the wheel pressure Pw is adjusted only by the first actuator YA during the normal operation of the braking control device SC, the wheel pressure Pw and the supply pressure Pm match (i.e., “Pm=Pw”).
In the first actuator YA, the pressure receiving area rm (also called a “master area”) of the master chamber Rm and the pressure receiving area ru (also called a “servo area”) of the servo chamber Ru are set equally. Therefore, “rm=ru” is true, and in a static state, “Pm=Pu” is true (here, friction of a seal member SL is ignored).
The supply pressure sensor PM is built in the second actuator YB and connected to the second controller EB by the signal line LPm. The first controller EA obtains the supply pressure Pm from the second controller EB through the communication bus BS.
In the second actuator YB, the rear wheel supply pressure sensor PMr is omitted, and only the front wheel supply pressure sensor PMf is provided as the supply pressure sensor PM. Therefore, only the front wheel supply pressure Pmf is adopted as ae signal of the supply pressure Pm.

The various braking forces are as follows.
A “vehicle body total braking force Fu” is an actual braking force acting on the entire vehicle JV. The target value corresponding to the vehicle body total braking force Fu is a “target vehicle body braking force Fv”.
The “friction braking force Fm” is a braking force actually generated in accordance with the wheel pressure Pw. The target value corresponding to the friction braking force Fm is a “target friction braking force Fn”.
The “regenerative braking force Fg” is a braking force actually generated by the regenerative device KG. The target value corresponding to the regenerative braking force Fg is a “target regenerative braking force Fh”. The target regenerative braking force Fh is calculated by the first braking unit SA (in particular, the first controller) and transmitted to the regenerative device KG (in particular, the regenerative controller EG) via the communication bus BS. In the regenerative device KG, the regenerative controller EG controls the generator GN so that the actual regenerative braking force Fg is brought close to and matches the target regenerative braking force Fh.
The “limit regenerative braking force Fx” is a maximum value (limit value) of the regenerative braking force Fg that can be generated by the regenerative device KG. Therefore, in the regenerative device KG, the regenerative braking force Fg is generated in a range (limit) up to the limit regenerative braking force Fx. The limit regenerative braking force Fx is calculated by the regenerative device KG (in particular, the regenerative controller EG) and transmitted to the first braking unit SA (in particular, the first controller EA) via the communication bus BS.

The entire pressure adjusting control will be described with reference to the flowchart of FIG. 4. The pressure adjusting control includes the following two in accordance with the operation state of the first braking unit SA. The first is pressure adjusting control when the operation of the braking control device SC is normal (called a “normal state”), and is called a “normal control”. The second is pressure adjusting control when an obtainment abnormality of the supply pressure Pm occurs in the first braking unit SA (called “abnormal state”), and is called “complement control”. In the “complement control”, excess or deficiency of the supply pressure Pm from the first braking unit SA due to the obtainment abnormality of the supply pressure Pm is compensated by the second braking unit SB.

In step S110, power supply (power feed) is performed to the introduction valve VA and the opening valve VB by the first controller EA. Due to this, the normally-closed introduction valve VA is opened, the normally-opened opening valve VB is closed, and the first mode in which the master pistons NM and NS and the braking operation member BP can be displaced separately is selected. In the first mode, the supply pressure Pm (i.e., the wheel pressure Pw) is adjusted independently of the operation of the braking operation member BP. At this time, the operation force Fp of the braking operation member BP is generated by the stroke simulator SS.

In step S120, the first controller EA reads signals such as the first and second operation displacements Spa and Spb and the supply pressure Pm (=Pmf). The operation displacement sensor SP includes the two operation displacement detection portions SPa and SPb (first and second detection portions). The first operation displacement Spa (detection value of the first detection portion SPa) is directly obtained through the first displacement signal line LSpa. The second operation displacement Spb (detection value of the second detection portion SPb) and the supply pressure Pm (detection value of the supply pressure sensor PM) are obtained from the second controller EB via the communication bus BS.

In step S120, the first controller EA calculates the operation displacement Sp based on the first and second operation displacements Spa and Spb. Specifically, the mean value of the first and second operation displacements Spa and Spb is determined as the operation displacement Sp (i.e., “Sp=(Spa+Spb)/2”). When one of the first and second operation displacements Spa and Spb cannot be obtained, the operation displacement Sp is determined by the other that can be obtained (i.e., “Sp=Spa” or “Sp=Spb”). Since the operation displacement sensor SP is made redundant, the operation displacement Sp is determined based on at least one of the first and second operation displacements Spa and Spb. The operation displacement Sp is transmitted from the first controller EA to the second controller EB via the communication bus BS.

In step S130, the target vehicle body braking force Fv (target value of the braking force acting on the entire vehicle) is calculated based on the operation displacement Sp and a calculation map Zfv. The target vehicle body braking force Fv is determined to be “0” when the operation displacement Sp is less than a predetermined displacement so in accordance with the calculation map Zfv. When the operation displacement Sp is equal to or greater than the predetermined displacement so, the target vehicle body braking force Fv is determined to increase from “0” as the operation displacement Sp increases from “0”. Here, the “predetermined displacement so” is a preset predetermined value (constant) representing play of the braking operation member BP.

In step S140, the first controller EA determines “whether or not the supply pressure Pm is appropriately obtained”. This determination processing is called “obtainment determination”. When the first braking unit SA can normally obtain (receive) the supply pressure Pm, the obtainment determination is affirmed, and the processing proceeds to step S150. On the other hand, when the supply pressure Pm cannot be appropriately obtained, the obtainment determination is negated, and the processing proceeds to step S180. For example, the cause of obtainment abnormality of the supply pressure Pm is at least one of “disconnection of communication line”, “malfunction of communication microcontroller (in particular, a receiving portion) of the first controller EA”, and “malfunction of communication microcontroller (in particular, a transmitting portion) of the second controller EB”.

In step S140, when the obtainment determination is affirmed, a determination flag FP (also called “obtainment flag”) is determined to be “0”. On the other hand, when the obtainment determination is negated, the obtainment flag FP is determined to be “1”. The “obtainment flag FP” is a control flag that indicates whether or not the supply pressure Pm in the first braking unit SA can be obtained. In the obtainment flag FP, “0” represents a normal state in which obtainment is normal, and “1” represents an abnormal state in which there is an abnormality in obtainment. When the communication bus BS is normal, the obtainment flag FP is transmitted from the first controller EA to the second controller EB via the communication bus BS.

### <<Processing of Normal Control>>

The processing of steps S150 to S170 corresponds to the normal control (pressure adjusting control when the supply pressure Pm is normally received) including the regenerative cooperative control. This processing is performed by the first controller EA. For example, in the normal control, only the first actuator YA is driven.

In step S150, the target regenerative braking force Fh and the target friction braking force Fn are calculated based on the target vehicle body braking force Fv and the limit regenerative braking force Fx. Specifically, the target regenerative braking force Fh is determined as a value equal to or less than the limit regenerative braking force Fx. For example, when the target vehicle body braking force Fv is equal to or less than the limit regenerative braking force Fx, the target regenerative braking force Fh is made equal to the target vehicle body braking force Fv, and the target friction braking force Fn is determined to be “0” (i.e., when “Fv≤Fx”, “Fh=Fv, Fn=0”). On the other hand, when the target vehicle body braking force Fv is greater than the limit regenerative braking force Fx, the target regenerative braking force Fh is made equal to the limit regenerative braking force Fx, and the target friction braking force Fn is determined to be “a value in which the limit regenerative braking force Fx (=Fh) is subtracted from the target vehicle body braking force Fv” (i.e., when “Fv>Fx”, “Fh=Fx, Fn=Fv−Fx=Fv−Fh”). The target regenerative braking force Fh is transmitted from the first controller EA to the regenerative controller EG via the communication bus BS. The regenerative controller EG controls the generator GN such that the actual regenerative braking force Fg is brought close to and matches the target regenerative braking force Fh.

In step S160, the target pressure Pt (=Ptf, Ptr) is calculated based on the target friction braking force Fn. The “target pressure Pt” is a target value corresponding to the supply pressure Pm. Since “Pm=Pw” during the normal operation of the braking control device SC, the target pressure Pt is also a target value corresponding to the wheel pressure Pw. Specifically, the target pressure Pt is determined by converting the target friction braking force Fn into the dimension of the supply pressure Pm (i.e., the wheel pressure Pw) based on specifications (a pressure receiving area of the wheel cylinder CW, an effective braking radius of the rotation member KT, a friction coefficient of the friction member MS, an effective radius of the wheel (tire), and the like) of the braking device SX and the like. Since “Pmf=Pmr”, the front wheel target pressure Ptf and the rear wheel target pressure Ptr are determined to be equal values (i.e., “Ptf=Ptr”).

In step S170, the first controller EA controls the first actuator YA so that the supply pressure Pm (actual value) is brought close to and matches the target pressure Pt (target value). Specifically, the first electric motor MA is driven, and the brake fluid BF is discharged from the first fluid pump QA. Due to this, the circulation flow KN of the brake fluid BF is generated in the reflux path HK. The pressure adjusting valve UA is driven and the circulation flow KN is throttled, thereby generating the servo pressure Pu. In the driving of the first actuator YA, the pressure adjusting valve UA is controlled by feedback control based on the supply pressure Pm so that the supply pressure Pm is brought close to the target pressure Pt.

### <<Processing of Complement Control>>

The pressure adjusting control (i.e., complement control) when the operation of the supply pressure sensor PM is normal but the supply pressure Pm is not normally received by the first braking unit SA will be described. The complement control is performed to compensate for excess or deficiency of the supply pressure Pm from the first braking unit SA. The processing of steps S190 and S200 by the second braking unit SB corresponds to the complement control.

When the obtainment determination in step S140 is negated, the operation of the regenerative device KG is stopped in step S180. For example, “Fh=0” or “FP=1” is transmitted from the first controller EA to the regenerative controller EG, and in the regenerative device KG, power generation by the generator GN is stopped. Due to this, the regenerative braking force Fg is made “0”, and the regenerative cooperative control is ended.

Alternatively, when a communication abnormality occurs in the first braking unit SA, an operation stop signal is not transmitted, and therefore the regenerative controller EG cannot obtain the target regenerative braking force Fh. Based on this, the regenerative controller EG identifies the abnormal state, and the power generation by the generator GN is stopped. Therefore, when an obtainment abnormality of the supply pressure Pm occurs, the regenerative braking force Fg is made “0”, and the regenerative cooperative control is ended. In step S180, since the operation of the regenerative device KG is stopped, the target friction braking force Fn is made equal to the target vehicle body braking force Fv (i.e., “Fn=Fv”).

In step S190, the target pressure Pt is obtained by the first and second controllers EA and EB. Here, the target pressure Pt of the first controller EA and the target pressure Pt of the second controller EB are determined as similar values. In step S190, since “Fh=0, Fg=0”, the target friction braking force Fn is equal to the target vehicle body braking force Fv (i.e., “Fn=Fv”). Therefore, the target friction braking force Fn calculated in accordance with the operation displacement Sp and the calculation map Zfv are converted into the target pressure Pt and determined based on the specifications of the braking device SX and the like. For example, the target pressure Pt is calculated by each of the first and second controllers EA and EB by a similar method based on the operation displacement Sp. In the “similar method”, the similar calculation map Zfv is adopted and the target pressure Pt is calculated in a state where the regenerative braking force Fg is not generated. However, the calculation map Zfv used for the first controller EA and the calculation map Zfv used for the second controller EB do not need to completely match each other, and it is sufficient that they are approximate to each other. The target pressure Pt calculated by the first controller EA may be obtained by the second controller EB via the communication bus BS. Alternatively, the target pressure Pt calculated by the second controller EB may be obtained by the first controller EA via the communication bus BS.

When the obtainment abnormality occurs due to disconnection of the communication line, signal transfer of the first and second operation displacements Spa and Spb via the communication bus BS cannot be performed. In this situation, since the first controller EA cannot obtain the second operation displacement Spb, the first operation displacement Spa is determined as the operation displacement Sp. Since the second controller EB cannot obtain the first operation displacement Spa, the second operation displacement Spb is determined as the operation displacement Sp. When the operation displacement sensor SP is operating normally, the first operation displacement Spa and the second operation displacement Spb are substantially equal.

From the above, in step S190, the target pressure Pt is obtained (or, calculation) by both the first and second controllers EA and EB by any of the methods described above. That is, each of the target pressures Pt of the first and second controllers EA and EB is calculated using a calculation map identical or approximate to that in the case of “Fh=0” in the normal control. Therefore, in any case, the target pressure Pt of the first braking unit SA and the target pressure Pt of the second braking unit SB are substantially equal values.

In step S190, the first actuator YA and the second actuator YB are both driven based on the target pressure Pt. Specifically, the first actuator YA is controlled by the first controller EA by a method in which the feedback control based on the supply pressure Pm is omitted from step S170. The detailed description of the method for driving the first actuator YA will be omitted.

In step S200, the deviation hP (called “fluid pressure deviation”) between the target pressure Pt and the supply pressure Pm is calculated based on the target pressure Pt and the supply pressure Pm. Specifically, the supply pressure Pm is subtracted from the target pressure Pt to determine the fluid pressure deviation hP (i.e., “hP=Pt−Pm”). In step S200, the second actuator YB is controlled by the second controller EB based on the fluid pressure deviation hp. The “fluid pressure deviation hp” is a state quantity representing a deviation between the supply pressure (i.e., the target pressure Pt) that should be output from the first braking unit SA and the supply pressure Pm actually generated. Therefore, when the supply pressure Pm is smaller than the target pressure Pt and an increase in the supply pressure Pm is needed (i.e., a case where the fluid pressure deviation hP is larger than “0”), the fluid pressure deviation hP is a target value for compensating for the deficiency of the supply pressure Pm and increasing the wheel pressure Pw. When the supply pressure Pm is larger than the target pressure Pt and a decrease in the supply pressure Pm is needed (i.e., a case where the fluid pressure deviation hP is smaller than “0”), the fluid pressure deviation hP is a target value for compensating the excessive supply pressure Pm and decreasing the wheel pressure Pw.

When the supply pressure Pm is smaller than the target pressure Pt and an increase in the wheel pressure Pw is needed, the second electric motor MB and the control valve UB are driven. Specifically, the second electric motor MB is driven, and the brake fluid BF is discharged from the second fluid pump QB. Due to this, the circulation flow KL of the brake fluid BF is generated in the communication path HS and the return path HL. When the fluid pressure deviation hP is equal to or greater than the pressure increase predetermined deviation hp, the control valve UB increases the supply pressure Pm by an amount of the fluid pressure deviation hP. Here, the “pressure increase predetermined deviation hp” is a preset positive predetermined value (constant). The adjustment increased from the supply pressure Pm is called “pressure increase control” in the complement control.

In the pressure increase control, the control valve UB is driven and the circulation flow KL is throttled, whereby a fluid pressure deviation is generated between the upstream side and the downstream side of the control valve UB. Due to this, the adjustment pressure Pq, which is the upstream side fluid pressure, is increased from the supply pressure Pm, which is the downstream side fluid pressure. That is, in the driving of the second actuator YB, the control valve UB is controlled such that the differential pressure (i.e., fluid pressure “Pq-Pm”) between the adjustment pressure Pq and the supply pressure Pm becomes the fluid pressure deviation hP. Since the adjustment pressure Pq is equal to the wheel pressure Pw, the fluid pressure in which the actual fluid pressure corresponding to the fluid pressure deviation hP (target value) is applied to the supply pressure Pm (actual value) is output as the wheel pressure Pw (actual value) from the second actuator YB (i.e., “Pw=Pm+hP”). In the pressure increase control, when the supply pressure Pm is smaller than the target pressure Pt, the control valve UB is appropriately driven, whereby the wheel pressure Pw is increased by an amount corresponding to the fluid pressure deviation hp from the supply pressure Pm.

On the other hand, when the supply pressure Pm is larger than the target pressure Pt and a decrease in the wheel pressure Pw is needed, the second electric motor MB, the inlet valve VI, and the outlet valve VO are driven. Specifically, when the fluid pressure deviation hP is less than a decompression predetermined deviation hq, the supply pressure Pm is decreased by an amount corresponding to the fluid pressure deviation hp by the inlet valve VI and the outlet valve VO, and is output as the wheel pressure Pw (i.e., “Pw=Pm−hP”). Here, the “decompression predetermined deviation hq” is a preset negative predetermined value (constant). The adjustment decreased from the supply pressure Pm is called “decompression control” in the complement control. In the decompression control, when the supply pressure Pm is larger than the target pressure Pt, the inlet valve VI and the outlet valve VO are appropriately driven (e.g., a driving method similar to anti-lock brake control), whereby the wheel pressure Pw is decreased by an amount of the fluid pressure deviation hp from the supply pressure Pm. The second electric motor MB is driven to return the brake fluid BF from the pressure adjusting reservoir RB to the upper part of the control valve UB.

The configuration of the braking control device SC and the pressure adjusting control will be summarized. The braking control device SC is a brake-by-wire type device in which the operation of the braking operation member BP (brake pedal) and the fluid pressure (wheel pressure Pw) of the wheel cylinder CW can be controlled independently. Specifically, in the first braking unit SA, one of the first mode (by-wire mode) in which the master piston NM and the braking operation member BP are displaced separately and the second mode (manual mode) in which the master piston NM and the braking operation member BP are displaced integrally is selected by the input portion NR. Due to this, the operation displacement Sp and the supply pressure Pm are independent in the first mode, and the operation displacement Sp and the supply pressure Pm are linked in the second mode. Since the supply pressure Pm is supplied as the wheel pressure Pw, the wheel pressure Pw is independently controlled with respect to the operation of the braking operation member BP by selecting the first mode.

The first braking unit SA is provided with the master cylinder CM, and the master chamber Rm and the servo chamber Ru that are partitioned by the master piston NM inserted into the master cylinder CM. As the servo pressure Pu supplied to the servo chamber Ru is increased, the supply pressure Pm is output from the master chamber Rm. When the entire device is normal, the first mode is selected in the first braking unit SA. The servo pressure Pu is adjusted based on the operation displacement Sp and the supply pressure Pm. Due to this, the supply pressure Pm is adjusted, and finally, the wheel pressure Pw is adjusted. Specifically, the first braking unit SA calculates the target pressure Pt based on the operation displacement Sp, and adjusts the servo pressure Pu so that the supply pressure Pm is brought close to and matches the target pressure Pt. That is, in the first braking unit SA, the fluid pressure feedback control is performed so that the supply pressure Pm, which is the output, is brought close to the target pressure Pt calculated with the operation displacement Sp as an input.

The second braking unit SB is a general-purpose unit for performing wheel independent control such as anti-lock brake control and anti-skid control. Since information on the supply pressure Pm is essential for performing of the wheel independent control, the supply pressure sensor PM is built in the second actuator YB and directly connected to the second controller EB. In order to perform the fluid pressure feedback control, the first controller EA obtains the supply pressure Pm through the communication bus BS. Since one supply pressure sensor PM is shared by the fluid pressure feedback control in the first braking unit SA and the wheel independent control in the second braking unit SB, the configuration is simplified as compared with a device in which the supply pressure sensor PM is provided in each of the first and second braking units SA and SB. That is, the braking control device SC performs the fluid pressure control including the feedback control, and the configuration thereof is simplified.

Furthermore, in the braking control device SC, even if the operation of the supply pressure sensor PM is normal, when obtainment abnormality of the supply pressure Pm is generated, the information on the supply pressure Pm cannot be used in the first braking unit SA (in particular, the first controller EA). Therefore, the first braking unit SA can perform open loop control (i.e., feedforward control), but cannot perform closed loop control (i.e., feedback control) based on the supply pressure Pm. Due to this, an error may occur between the target pressure Pt and the supply pressure Pm. Therefore, also in the second braking unit SB, the target pressure Pt is calculated based on the operation displacement Sp, and the deviation hp between the target pressure Pt and the supply pressure Pm is determined. The fluid pressure deviation hP calculated by the second braking unit SB is equal to the fluid pressure error in the first braking unit SA. In other words, the fluid pressure deviation hP is a state quantity representing excess or deficiency of the supply pressure Pm. Therefore, the wheel pressure Pw is adjusted (increased or decreased) by the complement control (i.e., pressure increase control and decompression control) in the second braking unit SB so as to compensate for the fluid pressure error (i.e., excess or deficiency) of the supply pressure Pm. Since the actual supply pressure Pm is compensated without excess or deficiency by the complement control, the pressure adjusting control is appropriately performed even at the time of obtainment abnormality. That is, in the braking control device SC, even if the operation is malfunctioning, the accuracy of the pressure adjusting control is secured by the complement control. Even when the complement control is performed, the first mode is selected in the first braking unit SA.

In the complement control in the second braking unit SB, the decompression control may be omitted, and only the pressure increase control may be performed. This is based on the fact that compensation for the decrease amount of the wheel pressure Pw is the most important in the complement control. In addition, when the inlet valve VI and the outlet valve VO are operated, sound and vibration may be generated. Therefore, silence of the braking control device SC can be improved by omitting the decompression control.

In the braking control device SC, “configuration in which the supply pressure sensor PM is built in the second actuator YB (called “former configuration”)” is adopted as a configuration in which one supply pressure sensor PM is shared, but conversely, “configuration in which the supply pressure sensor PM is built in the first actuator YA (called “latter configuration”)” is conceivable. In the latter configuration, when performing the complement control, the second controller EB needs to obtain the supply pressure Pm from the first controller EA through the communication bus BS. However, the former configuration is more advantageous than the latter configuration in terms of function dispersion and fail-safe. For example, when a communication abnormality occurs, in the latter configuration, the second braking unit SB (in particular, the second controller EB) cannot obtain the supply pressure Pm. Therefore, the complement control based on the supply pressure Pm cannot be performed. The supply pressure Pm is needed to perform the wheel independent control in the second braking unit SB, but the wheel independent control cannot be performed when the supply pressure Pm cannot be obtained. Therefore, the former configuration is an advantageous configuration in terms of function dispersion, fail-safe, and the like.

### <Drive Control of Pressure Adjusting Valve UA>

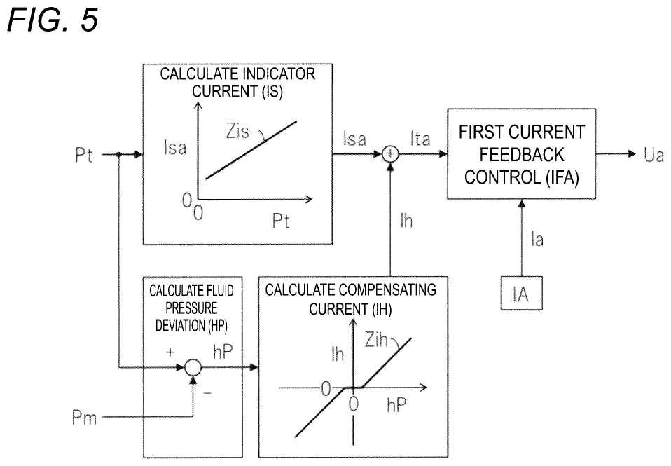

Details (in particular, the processing in steps S170 and S200) of the drive control of the pressure adjusting valve UA will be described with reference to the block diagram of FIG. 5. The processing of the drive control is performed by the first controller EA. The servo pressure Pu is adjusted by the pressure adjusting valve UA, and finally the supply pressure Pm is adjusted.

The drive control (i.e., the control at the normal time of the braking control device SC) of the pressure adjusting valve UA in step S170 includes an indicator current calculation block IS, a fluid pressure deviation calculation block HP, a compensating current calculation block IH, and a first current feedback control block IFA.

In the indicator current calculation block IS, an indicator current Isa is calculated based on the target pressure Pt and a preset calculation map Zis. The “indicator current Isa” is a target value related to the supply current Ia (first supply current) of the pressure adjusting valve UA necessary for achieving the target pressure Pt. The indicator current Isa is determined so as to increase with an increase in the target pressure Pt in accordance with the calculation map Zis. The indicator current calculation block IS corresponds to feedforward control based on the target pressure Pt.

In the fluid pressure deviation calculation block HP, a deviation hP (fluid pressure deviation) between the target pressure Pt and the supply pressure Pm is calculated. Specifically, the supply pressure Pm is subtracted from the target pressure Pt to determine the fluid pressure deviation hp (i.e., “hP=Pt−Pm”).

In the compensating current calculation block IH, a compensating current Ih is calculated based on the fluid pressure deviation hP and a preset calculation map Zih. The indicator current Isa is calculated corresponding to the target pressure Pt, but an error may occur between the target pressure Pt and the supply pressure Pm. The “compensating current Ih” is for compensating (reducing) this error. The compensating current Ih is determined so as to increase with an increase in the fluid pressure deviation hP in accordance with the calculation map Zih. Specifically, when the target pressure Pt is larger than the supply pressure Pm and the fluid pressure deviation hP has a positive sign, the compensating current Ih of the positive sign is determined so that the indicator current Isa is increased. On the other hand, when the target pressure Pt is smaller than the supply pressure Pm and the fluid pressure deviation hP has a negative sign, the compensating current Ih of the negative sign is determined so that the indicator current Isa is decreased. Here, the calculation map Zih is provided with a dead zone. The compensating current calculation block IH corresponds to feedback control based on the supply pressure Pm.

The compensating current Ih is applied to the indicator current Isa, and the first target current Ita is calculated (i.e., “Ita=Isa+Ih”). The “first target current Ita” is a final target value of the current supplied to the pressure adjusting valve UA. That is, the first target current Ita is determined as the sum of a feedforward term Isa and a feedback term Ih. Therefore, the drive control of the pressure adjusting valve UA includes feedforward control (processing of the indicator current calculation block IS) and feedback control (processing of the compensating current calculation block IH) in the fluid pressure.

In the first current feedback control block IFA, the first drive signal Ua is calculated such that the first supply current Ia is brought close to and matches the first target current Ita based on the first target current Ita (target value) and the first supply current Ia (actual value). Here, the first supply current Ia is detected by the first supply current sensor IA provided in the first drive circuit DRa. In the first current feedback control block IFA, if “Ita>Ia”, the first drive signal Ua is determined such that the first supply current Ia increases. On the other hand, if “Ita<Ia”, the first drive signal Ua is determined such that the first supply current Ia decreases. That is, in the first current feedback control block IFA, feedback control related to current is performed. Therefore, the drive control of the pressure adjusting valve UA includes feedback control related to the current in addition to feedback control related to the fluid pressure.

When the obtainment abnormality occurs in the supply pressure Pm (i.e., the processing of step S200), the first controller EA calculates the indicator current Isa but cannot calculate the fluid pressure deviation hp, and therefore the compensating current Ih cannot be calculated (i.e., “Ih=0”). As a result, the indicator current Isa is determined as the target current Ita (i.e., “Ita=Isa”). At the time of obtainment abnormality, in the drive control of the pressure adjusting valve UA, the feedback control based on the supply pressure Pm is not performed, and only the feedforward control based on the target pressure Pt is performed.

### <Drive Control of Control Valve UB>

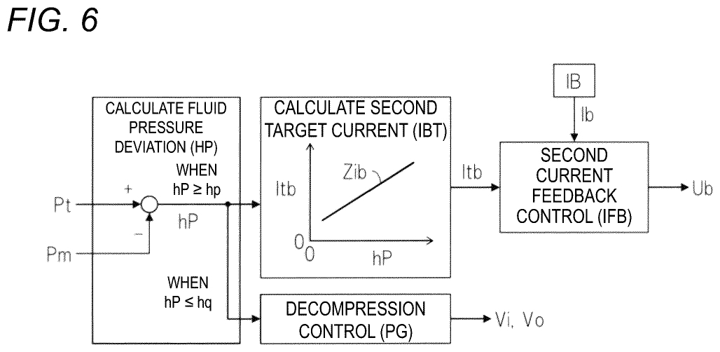

Details (i.e., the processing in step S200) of the drive control of the control valve UB in the complement control will be described with reference to the block diagram of FIG. 6. The processing of the complement control is performed by the second controller EB. Before the obtainment abnormality of the supply pressure Pm is determined (i.e., a case of “FP=0”), the operation of the second actuator YB is stopped. At the time point when the obtainment determination in step S140 is negated and the obtainment abnormality is determined (i.e., switching time point from “FP=0” to “FP=1”), the second actuator YB starts the complement control.

In the complement control, the wheel pressure Pw is adjusted based on the fluid pressure deviation hp. The complement control includes pressure increase control for increasing the wheel pressure Pw and decompression control for decreasing the wheel pressure Pw. The complement control is provided with a dead zone in a range where “the fluid pressure deviation hP is larger than the decompression predetermined deviation hq (preset negative constant) and smaller than the pressure increase predetermined deviation hp (preset positive constant)”.

The drive control of the control valve UB in the complement control includes the fluid pressure deviation calculation block HP, a second target current calculation block IBT, a second current feedback control block IFB, and a decompression control block PG.

In the fluid pressure deviation calculation block HP, the deviation hp between the target pressure Pt and the supply pressure Pm is calculated. The processing of the fluid pressure deviation calculation block HP is similar to the processing of the deviation calculation block HP of the first controller EA. Specifically, the supply pressure Pm is subtracted from the target pressure Pt calculated based on the operation displacement Sp to determine the fluid pressure deviation hP (i.e., “hP=Pt−Pm”). Here, the target pressure Pt is calculated by the second braking unit SB based on a method similar to the method of calculating the target pressure Pt in the first braking unit SA. Specifically, the target pressure Pt is calculated based on a calculation map (Zfv or the like) that is the identical to or approximate to the calculation map adopted in the processing of steps S130 to S160 in “Fh=0” or the processing of step S190. In the complement control, the fluid pressure deviation hP is treated as a target value of the differential pressure between the supply pressure Pm and the wheel pressure Pw.

When the supply pressure Pm is smaller than the target pressure Pt (specifically, when the fluid pressure deviation hP is equal to or greater than the pressure increase predetermined deviation hp and exceeds the dead zone of the complement control), the second target current Itb is calculated by the second target current calculation block IBT based on the fluid pressure deviation hP and a preset calculation map Zib. The “second target current Itb” is a target value related to the supply current Ib (second supply current) of the control valve UB necessary for generating the differential pressure of an amount corresponding to the fluid pressure deviation hp by the control valve UB. The second target current Itb is determined to increase with a increase in the fluid pressure deviation hP in accordance with the calculation map Zib. The processing of the second target current calculation block IBT is similar to the processing of the indicator current calculation block IS described above (i.e., feedforward control based on fluid pressure).

In the second current feedback control block IFB, the second drive signal Ub is calculated such that the second supply current Ib is brought close to and matches the second target current Itb based on the second target current Itb (target value) and the second supply current Ib (actual value). Here, the second supply current Ib is detected by a second supply current sensor IB provided in the second drive circuit DRb. In the second current feedback control block IFB, if “Itb>Ib”, the second drive signal Ub is determined such that the second supply current Ib increases. On the other hand, if “Itb<Ib”, the second drive signal Ub is determined such that the second supply current Ib decreases. In the second current feedback control block IFB, feedback control related to the current similar to the first current feedback control block IFA described above is performed. The second target current calculation block IBT and the second current feedback control block IFB correspond to the processing of the pressure increase control.

When the supply pressure Pm is larger than the target pressure Pt (specifically, when the fluid pressure deviation hP is equal to or less than the decompression predetermined deviation hq and exceeds the dead zone of the complement control), the inlet valve VI and the outlet valve VO are controlled by the decompression control block PG. In the decompression control block PG, the drive signals Vi and Vo of the inlet valve VI and the outlet valve VO are determined so that the supply pressure Pm is reduced by an amount corresponding to the fluid pressure deviation hP. The decompression control block PG corresponds to the processing of the decompression control.

The drive control of the control valve UB described above is open loop control, but may be configured as closed loop control including feedback control related to fluid pressure. In this configuration, an adjustment pressure sensor (not illustrated) is provided below the control valve UB so as to detect the adjustment pressure Pq. The second target current Itb is finely adjusted based on the deviation between the supply pressure Pm and the adjustment pressure Pq by a similar method to the compensating current calculation block IH.

### <Configuration of Two-System Pressure Adjusting>

In the above-described embodiment, in the normal state of the braking control device SC, the operation of the second actuator YB is stopped, and only the first actuator YA is driven. In this case, since the front wheel and rear wheel supply pressures Pmf and Pmr (=Pm) are equal, the front wheel and rear wheel wheel pressures Pwf and Pwr (=Pw) are equal. Such pressure adjusting control is called “one-system pressure adjusting”. In the configuration of the one-system pressure adjusting, since the second actuator YB is not driven in the normal control, a target pressure Ptm (called “target supply pressure”) corresponding to the supply pressure Pm and a target pressure Ptw (called “target wheel pressure”) corresponding to the wheel pressure Pw match (i.e., “Pt=Ptm=Ptw”).

In place of the configuration of the one-system pressure adjusting, the second actuator YB may be driven in addition to the first actuator YA when the braking control device SC is normal, and the front wheel and rear wheel wheel pressures Pwf and Pwr may be adjusted separately. Specifically, the identical supply pressures Pmf and Pmr (=Pm) are supplied from the first actuator YA to the second actuator YB. The wheel pressure (e.g., the front wheel wheel pressure Pwf) of one side system corresponding to the wheel including the regenerative device KG is adjusted by the second actuator YB to be smaller than the wheel pressure (e.g., the rear wheel wheel pressure Pwr) of the other side system corresponding to the wheel not including the regenerative device KG. The pressure adjusting control in which the front wheel and rear wheel wheel pressures Pwf and Pwr are independently and individually adjusted by the drive of the second actuator YB is called “two-system pressure adjusting”. In regenerative cooperative control, as compared with the one-system pressure adjusting, the two-system pressure adjusting improves the regenerative efficiency and optimizes the braking force distribution between the front and rear wheels.

In the configuration of the two-system pressure adjusting, since the second actuator YB is driven even in the normal state, the target pressure Ptm (target supply pressure) corresponding to the supply pressure Pm and the target pressure Ptw (target wheel pressure) corresponding to the wheel pressure Pw are different. Therefore, the first actuator YA performs feedforward control and feedback control so that the supply pressure Pm (=Pmf, Pmr) is brought close to and matches the target supply pressure Ptm. The second actuator YB performs feedforward control based on differential pressures hPf and hPr (called “front wheel and rear wheel target differential pressure”) between front wheel and rear wheel target wheel pressures Ptwf and Ptwr and the target supply pressure Ptm (or the actual supply pressure Pm).

The configuration of the two-system pressure adjusting is also applied with complement control. At the time point when the obtainment abnormality is determined (i.e., time point at which the determination flag FP is switched to “1”), the regenerative cooperative control is ended, and the generation of the regenerative braking force Fg is stopped. In the complement control, the supply pressure Pm (actual value) is adjusted (increased or decreased) by an amount corresponding to the fluid pressure deviation hP (target value) by the second actuator YB so as to compensate for excess or deficiency of the supply pressure Pm output from the first braking unit SA. Also in the configuration of the two-system pressure adjusting, similarly to the configuration of the one-system pressure adjusting, the pressure adjusting control is appropriately performed at the time of obtainment abnormality, and excess or deficiency of the supply pressure Pm from the first braking unit SA is compensated with an appropriate amount.

### OTHER EMBODIMENTS

Hereinafter, other embodiments will be described. Other embodiments also achieve similar effects to those described above (simplification of the configuration, securing of pressure adjusting accuracy at the time of obtainment abnormality, and the like).

In the above-described embodiment, the target values (Fv, Fx, Fh, Fn, and the like) of various braking forces are calculated by the dimension of the longitudinal force acting on the vehicle JV. Alternatively, they may be calculated by the dimension of deceleration of the vehicle JV or the dimension of torque of the wheel WH. This is based on the fact that the state quantity (called “state quantity related to force”) from the longitudinal force to the vehicle deceleration is equivalent. Therefore, the target pressure Pt is calculated based on the state quantity related to the force from the longitudinal force acting on the vehicle JV to the deceleration of the vehicle JV.

In the above-described embodiment, the front-rear type is adopted as the two-system braking system. Alternatively, a diagonal type (also called “X type”) may be adopted as the two-system braking system. In this configuration, one of the two master chambers Pm is connected to the left front wheel wheel cylinder and the right rear wheel wheel cylinder, and the other of the two master chambers Pm is connected to the right front wheel wheel cylinder and the left rear wheel wheel cylinder. However, in the configuration in which the two-system pressure adjusting is adopted, the braking system is limited to the front-rear type.

In the above-described embodiment, as the pressure adjusting portion CA, one (so-called reflux type configuration) that adjusts the servo pressure Pu by the pressure adjusting valve UA throttling the circulation flow KN of the brake fluid BF discharged from the fluid pump QA has been exemplified. Alternatively, in the pressure adjusting portion CA, the pressure accumulated in an accumulator may be adjusted by a linear electromagnetic valve (so-called accumulator type configuration). The volume in the cylinder may be increased or decreased by the piston directly driven by the electric motor to adjust the servo pressure Pu (so-called electric cylinder type configuration). Since the output of the electric motor is proportional to the supply current, it is possible to perform feedforward control based on the target pressure Pt, similarly to the pressure adjusting valve UA. In any configuration, the supply pressure Pm is fed back as an output signal by the pressure adjusting portion CA, and the fluid pressure Pu (servo pressure) of the servo chamber Ru is electrically adjusted.

In the above-described embodiment, the tandem type is exemplified as the master cylinder CM. Alternatively, a single type master cylinder CM may be adopted. In this configuration, the secondary master piston NS is omitted. One master chamber Rm is connected to the four wheel cylinders CW. In this configuration, the identical supply pressures Pmf and Pmr (=Pm) are output from the master cylinder CM.

In the configuration adopting the single type master cylinder CM, the master chamber Rm may be connected to the front wheel wheel cylinder CWf, and the rear wheel wheel cylinder CWr may be directly supplied with the servo pressure Pu from the pressure adjusting portion CA. In this configuration, the front wheel supply pressure Pmf is output from the master cylinder CM. On the other hand, the servo pressure Pu is output as the rear wheel supply pressure Pmr from the pressure adjusting portion CA.

In the above-described embodiment, the pressure receiving area rm (master area) of the master chamber Rm and the pressure receiving area ru (servo area) of the servo chamber Ru are set equally in the application portion AP. The master area rm and the servo area ru need not be equal. In the configuration in which the master area rm and the servo area ru are different, conversion calculation between the supply pressure Pm and the servo pressure Pu is possible based on the ratio between the servo area ru and the master area rm (i.e., conversion based on “Pm·rm=Pu·ru”).

In the above-described embodiment, in the first braking unit SA, the supply pressure Pm is output via the master cylinder CM. That is, the application portion AP and the pressure adjusting portion CA are arranged in series in the transfer route of the fluid pressure, and the servo pressure Pu supplied from the pressure adjusting portion CA is transmitted as the supply pressure Pm via the master piston NM. Alternatively, the application portion AP and the pressure adjusting portion CA may be arranged in parallel. Specifically, each of the application portion AP (in particular, the master cylinder CM) and the pressure adjusting portion CA is directly connected to the second actuator YB. In the first mode, “connection between the pressure adjusting portion CA and the second actuator YB” is selected, and in the second mode, “connection between the application portion AP and the second actuator YB” is selected. For example, the selection is achieved by an on/off electromagnetic valve (called a “selector valve”). In the first mode in the configuration, the servo pressure Pu generated in the pressure adjusting portion CA is directly output as the supply pressure Pm not via the application portion AP. At this time, the application portion AP is connected to the stroke simulator SS, and the operation force Fp of the braking operation member BP is generated by the simulator SS. On the other hand, in the second mode, the fluid pressure in the master chamber Rm generated by the operation of the braking operation member BP is output as the supply pressure Pm. At this time, the application portion AP is separated from the simulator SS.

In the above-described embodiment, the braking control device SC is applied to the vehicle JV in which the rear wheel WHr does not include the regenerative device KG. The braking control device SC may be applied to the vehicle JV in which the rear wheel WHr includes the regenerative device KG.

### <Summary of Embodiments>

Hereinafter, embodiments of the braking control device SC will be summarized. The braking control device SC is a brake-by-wire type device that can independently adjust the operation displacement Sp of the braking operation member BP and the fluid pressure Pw (wheel pressure) of the wheel cylinder CW.

The braking control device SC includes the “first braking unit SA (first unit) that outputs the supply pressure Pm in accordance with the operation displacement Sp (operation amount) of the braking operation member BP”, the “second braking unit SB (second unit) that is provided between the first braking unit SA and the wheel cylinder CW, and adjusts the supply pressure Pm and outputs the wheel pressure Pw to wheel cylinder CW”, the “communication bus BS that performs signal communication between the first braking unit SA and the second braking unit SB”, the “operation displacement sensor SP (operation amount sensor) that is connected to the first braking unit SA and detects the operation displacement Sp (operation amount)”, and the “supply pressure sensor PM that is connected to the second braking unit SB and detects the supply pressure Pm”. In the braking control device SC, the first braking unit SA calculates the target pressure Pt based on the operation displacement Sp, and obtains the supply pressure Pm from the second braking unit SB via the communication bus BS. The first braking unit SA performs the feedback control so that the supply pressure Pm matches the target pressure Pt.

The second braking unit SB (in particular, the second actuator YB) includes the supply pressure sensor PM so as to perform wheel independent control such as anti-lock brake control and anti-skid control. The first braking unit SA does not include the supply pressure sensor PM, and a signal of the supply pressure Pm is input via the communication bus BS. In the braking control device SC, one supply pressure sensor PM is shared in various controls of pressure adjusting control and wheel independent control (anti-lock brake control, anti-skid control, and the like). Due to this, the overall configuration of the braking control device SC is simplified.

In the braking control device SC, the operation displacement sensor SP is connected to the second braking unit SB in addition to the first braking unit SA. When the first braking unit SA cannot obtain the supply pressure Pm (specifically, when the supply pressure sensor PM is normal but the first braking unit SA cannot obtain the signal Pm from the supply pressure sensor PM), the second braking unit SB calculates the target pressure Pt based on the operation displacement Sp. The wheel pressure Pw is adjusted based on the deviation hp between the target pressure Pt and the supply pressure Pm. For example, in the second braking unit SB, when the supply pressure Pm is smaller than the target pressure Pt, the wheel pressure Pw is increased by an amount corresponding to the deviation hP.

A situation in which the supply pressure sensor PM normally operates but the supply pressure Pm cannot be obtained in the first braking unit SA occurs due to an abnormality of the communication bus BS. When the first braking unit SA cannot obtain the supply pressure Pm, the feedback control described above cannot be performed, and only the feedforward control is performed in the pressure adjusting control. Therefore, the supply pressure Pm output from the first braking unit SA can include an error with respect to the target pressure Pt.

In the braking control device SC, since the operation displacement sensor SP is connected to both the first and second braking units SA and SB, even if an abnormality is generated in the communication bus BS, the first and second braking units SA and SB can obtain the operation displacement Sp. Furthermore, the second braking unit SB calculates the target pressure Pt based on a method similar to the method of calculating the target pressure Pt in the first braking unit SA. For example, the second braking unit SB calculates the target pressure Pt based on an identical or approximate calculation map with respect to the calculation map of the first braking unit SA. Therefore, the target pressure Pt calculated by the second braking unit SB and the target pressure Pt calculated by the first braking unit SA are substantially the same. When the braking control device SC is normal (i.e., when no obtainment abnormality of the supply pressure Pm occurs), the fluid pressure deviation hP calculated by the first braking unit SA and the fluid pressure deviation hp calculated by the second braking unit SB are equal. In other words, the fluid pressure deviation hp in the second braking unit SB represents a fluid pressure error due to the fact that the feedback control is not performed. Therefore, in the second braking unit SB, an appropriate amount is increased or decreased with respect to the supply pressure Pm based on this fluid pressure deviation hp, and is output as the wheel pressure Pw. This secures the accuracy of the fluid pressure control even when the braking control device SC is malfunctioning and the first braking unit SA cannot obtain the supply pressure Pm.

In particular, in a situation where the sufficient supply pressure Pm is not generated, there is a concern that the deceleration of the vehicle JV is insufficient. In the braking control device SC, when the supply pressure Pm is smaller than the target pressure Pt, the wheel pressure Pw is increased from the supply pressure Pm by a pressure corresponding to the fluid pressure deviation hP. Since this secures the appropriate wheel pressure Pw, the vehicle JV decelerates in accordance with the braking instruction of the driver (i.e., the operation displacement Sp). The braking control device SC has a configuration that can secure the pressure adjusting accuracy of the wheel pressure Pw even when the supply pressure Pm cannot be obtained, and has a simple configuration.

1. A braking control device for a vehicle comprising:
a first unit that outputs a supply pressure in accordance with an operation amount of a braking operation member;
a second unit that is provided between the first unit and a wheel cylinder, adjusts the supply pressure, and outputs a wheel pressure to the wheel cylinder;
a communication bus that performs signal transfer between the first unit and the second unit;
an operation amount sensor that is connected to the first unit and detects the operation amount; and
a supply pressure sensor that is connected to the second unit and detects the supply pressure, wherein
the first unit
calculates a target pressure based on the operation amount,
obtains the supply pressure from the second unit via the communication bus, and
performs feedback control so as to cause the supply pressure to match the target pressure.

2. The braking control device for a vehicle according to claim 1, wherein
the operation amount sensor is connected also to the second unit, and
when the first unit cannot obtain the supply pressure,
the second unit calculates the target pressure based on the operation amount, and adjusts the wheel pressure based on a deviation between the target pressure and the supply pressure.

3. The braking control device for a vehicle according to claim 2, wherein
the second unit increases the wheel pressure by an amount corresponding to the deviation when the supply pressure is smaller than the target pressure.
